(19) United States
(12) Patent Application Publication
(10) Pub. No.: US 2009/0176637 A1
(43) Pub. Date: Jul. 9, 2009

(54) OA APPARATUS ROLLER

(75) Inventors: Yoshimasa Suzuki, Sennan-Gun (JP); Masahiro Habuka, Sennan-Gun (JP); Yoshitaka Ikeda, Sennan-Gun (JP)

Correspondence Address: OSHA LIANG L.L.P., TWO HOUSTON CENTER, 909 FANNIN, SUITE 3500, HOUSTON, TX, 77010, US

(73) Assignee: SUMITOMO ELECTRIC FINE POLYMER, INC., Osaka (JP)

(21) Appl. No.: 12/347,849

(22) Filed: Dec. 31, 2008

Related U.S. Application Data
(63) Continuation-in-part of application No. 12/335,229, filed on Dec. 15, 2008.

(30) Foreign Application Priority Data
Dec. 27, 2007 (JP) 2007-336959
Dec. 27, 2007 (JP) 2007-336962

(51) Int. Cl. F16C 13/00

(52) U.S. Cl. 492/56

(57) ABSTRACT

The invention offers an OA apparatus roller that has a surface layer formed by applying fluororesin and baking it, that has various excellent properties without impairing the parting ability and thermal conductivity, and that is suitable for mass production. An OA apparatus roller is produced by forming an elastic layer and a surface layer in this order on a core metal. In the roller, the surface layer is composed of a plurality of fluororesin layers and has a thickness of 6 to 30 μm. An OA apparatus roller has a structure in which of the multiple fluororesin layers forming the surface layer, at least one layer is a fluororesin layer containing filler. An OA apparatus roller has a structure in which of the multiple fluororesin layers forming the surface layer, the outermost layer is a fluororesin layer containing no filler and at least one layer other than the outermost layer is a fluororesin layer containing filler.

### CROSS-REFERENCE TO RELATED APPLICATIONS

The present application is a Continuation-In-Part application of U.S. patent application Ser. No. 12/335,229, Entitled “Method of Producing OA Apparatus Roller and OA Apparatus Roller,” filed by Yoshimasa Suzuki, et al. on Dec. 15, 2008, the contents of which are hereby incorporated by reference in their entirety herein.

### BACKGROUND OF THE INVENTION

1. Field of the Invention

The present invention relates to an OA apparatus roller to be used, for example, as a fixing roller and a pressing roller of a fixing section of an OA apparatus, such as a copier, and a developing roller and a charging roller of a developing section of the foregoing OA apparatus.

2. Description of the Related Art

Generally, this type of roller has a structure in which a rubber layer as an elastic layer is formed on the outer circumference of a core metal and a surface layer is formed on the elastic layer. The surface layer is composed of a fluororesin layer made of tetrafluoroethylene-perfluoroalkylvinylether copolymer (PFA), polytetrafluoroethylene (PTFE), fluorinated ethylene-propylene copolymer (FEP), or the like, so that a parting ability is obtained.

In order to achieve excellent functions in fixing, developing, and so on for meeting the requirement of high-speed operation and to improve the durability and other properties, the surface layer of an OA apparatus roller contains various fillers for obtaining electrical conductivity, thermal conductivity, wear resistance, strength, and another property.

However, the containing of filler causes problems of both the decreasing in parting ability of the fluororesin layer and the impairing of its softness needed to obtain a high picture quality. Consequently, it is extremely difficult to obtain an OA apparatus roller having various good properties by using a surface layer composed of a single layer.

To solve the problem, it is conceivable to form a structure in which the fluororesin layer is composed of a plurality of layers. In this case, whereas a layer containing filler to obtain various properties is positioned at the inner side of the layers, a layer containing no filler is positioned as the outermost layer, so that the parting ability of the fluororesin layer can be secured. In addition, this structure is advantageous in that the defect caused by pinholes can be decreased by the multilayer structure.

However, when the fluororesin layer is composed of a plurality of layers, depending on the method of forming the fluororesin layer, the thickness of the fluororesin layer may increase or the elastic layer may deteriorate.

For example, in the powder-coating method in which a fluororesin layer is formed by using powder of fluororesin, one layer has a thickness of at least 20 μm. Therefore, when a multilayer structure is employed, the total thickness of the fluororesin layers becomes as thick as 40 μm or more. This increased thickness causes a problem of the decreasing of the thermal conductivity, making it difficult to meet the requirement of high-speed operation. Furthermore, the thick surface layer decreases its softness, possibly decreasing the picture quality.

On the other hand, there is a method of forming a surface layer composed of a plurality of fluororesin layers by applying the method of forming a surface layer using a thin fluororesin tube (see Patent literature 1). In this case, after the multiple fluororesin tubes are slipped over the rubber layer (the elastic layer), it is necessary to bond the tubes by baking them. At this moment, the baking must be performed at a temperature as high as 400° C. or more. In this case, however, the rubber layer, which is inferior in heat-resisting property to the fluororesin, deteriorates, rendering this method impracticable. Furthermore, when tubes are used, it is difficult to handle them and they themselves have a problem of high cost. As a result, an OA apparatus roller provided with a surface layer composed of a plurality of fluororesin layers has not been in practical use.

On the other hand, to form a thin fluororesin layer, another method is known in which a fluororesin dispersion is used to form the layer.

One of the methods of forming a fluororesin layer using the above-described fluororesin dispersion is to form a fluororesin layer by applying the fluororesin dispersion onto the outer circumferential surface of the rubber layer and then by performing a baking operation. However, to obtain a surface layer having a good property by using this method, it is necessary to perform the baking sufficiently for a long time. As with the foregoing method of using tubes, when the baking is performed for a long time, because the baking must be performed at a temperature as high as 400° C. or more, the rubber layer, which is inferior in heat-resisting property to the fluororesin, deteriorates, thereby causing a problem.

Yet another method of producing the roller is known, which also forms a fluororesin layer by using the fluororesin dispersion. According to this method of producing an OA apparatus roller, the surface layer is formed without adversely affecting the rubber layer by the heat at the time the fluororesin is baked. This method is explained below. First, a fluororesin dispersion is applied onto the inner circumferential surface of the hollow cylindrical mold. A fluororesin layer is formed by performing the baking. Next, a core metal is inserted into the hollow space of the hollow cylindrical mold. The material for forming the rubber layer is injected into the space between the fluororesin layer and the core metal. After the vulcanization is performed, the product is drawn out of the hollow cylindrical mold (hereinafter also referred to as releasing from the mold) to complete the production. According to this method, the rubber layer is not affected by the baking temperature. Consequently, the fluororesin can be completely baked and the rubber layer can be prevented from deteriorating.

In the case of the above-described method, however, it has been found that after the product is drawn out of the hollow cylindrical mold, the surfactant, film-thickening agent, and viscosity-increasing agent contained in the coating material (a fluororesin dispersion) remain on the inner circumferential surface of the hollow cylindrical mold as the decomposition products produced at the time of the baking. Consequently, when the mold is used repeatedly, the parting ability of the inner circumferential surface of the hollow cylindrical mold is decreased. Finally, the releasing from the mold becomes impossible. In addition, it has also been found that the cleaning operation of the hollow cylindrical mold for removing these residual substances to recover the parting ability is extremely cumbersome, causing the problem that this method is unsuitable for mass production.

As described above, conventional OA apparatus rollers have difficulty in forming a thin fluororesin layer. As a result, when a surface layer composed of a plurality of fluororesin layers is formed, there have been problems in that it is difficult to meet the requirement of high-speed operation because the thick surface layer decreases the thermal conductivity and that the picture quality becomes inferior because the softness of the surface layer is impaired. Consequently, it has been difficult to offer an OA apparatus roller that has various excellent properties, that can meet the requirement of high-speed operation, and that can achieve a high picture quality.

Patent literature 1: the published Japanese patent application Tokukai 2004-276290.

### SUMMARY OF THE INVENTION

An object of the present invention is to offer an OA apparatus roller that has various excellent properties, that can meet the requirement of high-speed operation, and that can achieve a high picture quality.

A fluororesin dispersion usually has a surfactant content of 15 to 20 wt % or so to have a dispersion stability of the fluororesin powder and to achieve a good wettability with the object to which it is to be applied. To increase the film-forming ability, it also has a film-thickening-agent content of 10 to 15 wt % or so and a viscosity-increasing-agent content of 10 to 15 wt % or so.

The present inventor has found that because of the presence of the foregoing ingredients, when the baking is incomplete, the surfactant, film-thickening agent, and viscosity-increasing agent remain in the fluororesin layer after the baking, so that the parting ability of the fluororesin layer is decreased.

In view of the above finding, the present inventor has diligently studied and has found that in the case where the thickness of the film is sufficiently reduced, even when the amounts of the surfactant, film-thickening agent, and viscosity-increasing agent are decreased, the film can be formed. It has also been found that when the amounts of these ingredients are decreased, it is possible to eliminate the remaining of these ingredients without performing a long-time complete baking, thereby preventing the parting ability from decreasing. In other words, the present inventor has found that the above-described method enables the formation of a fluororesin layer that combines a reduced film thickness and a parting ability.

According to the foregoing method in which not only is the film thickness decreased but also the amounts of the surfactant, film-thickening agent, and viscosity-increasing agent contained in the fluororesin dispersion are decreased, the baking can be performed in a short time. As a result, the present inventor has found that this method can produce an excellent OA apparatus roller that is almost free form the influence of the deterioration of the rubber layer caused by the baking temperature.

Furthermore, the present inventor has found that in the method of forming a fluororesin layer by applying the fluororesin dispersion onto the inner surface of a hollow cylindrical mold and then by performing a baking operation, the residual substances on the inner surface of the hollow cylindrical mold are decomposition products of the surfactant, film-thickening agent, and viscosity-increasing agent as described above.

It has been found that by significantly reducing the amounts of the surfactant, film-thickening agent, and viscosity-increasing agent, the adhering of the foreign matters can be prevented from occurring. Consequently the present inventor has found that in the method of forming a fluororesin layer by using a hollow cylindrical mold, by using a fluororesin dispersion containing significantly reduced amounts of the surfactant, film-thickening agent, and viscosity-increasing agent, an OA apparatus roller can be produced that enables the performing of a sufficient baking without deteriorating the rubber layer at all and that is suitable for mass production.

Because a roller having a thin surface layer can be realized as described above, the present invention can offer an OA apparatus roller that can secure the good thermal conductivity and softness of the layers on the core metal, that realizes a high picture quality, and that meets the requirement of high-speed operation.

In addition, because a thin film can be formed, even when a plurality of layers are formed, good thermal conductivity can be secured. By giving different properties to the individual layers while satisfying the requirement of high-speed operation, the present invention can offer an OA apparatus roller that has multiple properties, which has been difficult to achieve with a single layer.

By forming the surface layer using a plurality of layers, the defect caused by pinholes can be decreased and the manufacturing yield is increased. As a result, the present invention can offer an OA apparatus roller low in cost.

The study of the thickness of the surface layer has revealed that if the thickness is less than 6 μm, it is difficult to function as the surface layer and that if the thickness is more than 30 μm, not only is its softness insufficient to the extent that the picture quality is reduced to an unsatisfactory level but also its thermal conductivity is low, so that the surface layer does not have sufficient ability to meet the requirement of high-speed operation.

In addition, it is desirable that the total content of the surfactant, film-thickening agent, and viscosity-increasing agent contained in the fluororesin dispersion be 1.0 to 5 wt %.

The present invention offers an OA apparatus roller that is provided with a core metal, an elastic layer, and a surface layer. The OA apparatus roller has the following features:
(a) the elastic layer and the surface layer are formed in this order on the core metal, and
(b) the surface layer is composed of a plurality of fluororesin layers and has a thickness of 6 to 30 μm.

As described above, the present invention offers an OA apparatus roller. The concrete production method of the roller is not particularly limited.

When the multiple fluororesin layers are laminated, it is desirable that the surface of the previously formed fluororesin layer be treated through the plasma treatment, the electrical-discharge machining, the chemical etching, or the like to increase the wettability before applying the fluororesin dispersion. This process enables the formation of a thin smooth film having a better bonding property. It is also desirable that the surface of the fluororesin layer be treated through the plasma treatment or the like to increase the wettability with the elastic layer or the like.

The elastic layer is not particularly limited; various types of elastic layer may be employed. For example, various types of rubber may be used, such as solid rubber or spongelike rubber (balloon rubber).

It is desirable that the core metal of the OA apparatus roller in the present invention be composed of aluminum, iron, carbon steel, stainless steel, or the like.

According to the present invention, the surface layer may have a thickness of 6 to 20 μm.

As described above, when the surface layer has a thickness of 6 to 20 μm, the thermal conductivity can be further increased. In addition, it is desirable that the multiple fluororesin layers have a total thickness of at most 20 μm, more desirably at most 15 μm, and most desirably at most 12 μm.

According to the present invention, of the multiple fluororesin layers forming the surface layer, at least one layer may be a fluororesin layer containing filler.

As described above, when the multiple fluororesin layers forming the surface layer include at least one fluororesin layer containing filler, the surface layer can obtain improved properties in electrical conductivity, thermal conductivity, wear resistance, strength, and so on. Therefore, the present invention can offer an OA apparatus roller that has various excellent properties and that can obtain higher performance.

The types of filler having electrical conductivity include a metallic powder, such as a Cu powder and an Al powder, and an ion salt. The types of filler having thermal conductivity and wear resistance include SiC, TiO₂, and BN.

According to the present invention, of the multiple fluororesin layers forming the surface layer, the outermost layer may be a fluororesin layer containing no filler.

As described above, when the outermost layer of the multiple fluororesin layers forming the surface layer is composed of a fluororesin layer containing no filler and at least one layer other than the outermost layer is composed of a fluororesin layer containing filler, the surface layer can secure softness and good parting ability. Furthermore, the present invention can offer an OA apparatus roller that has various excellent properties and that can obtain higher performance.

According to the present invention, the multiple fluororesin layers may be composed of at least one member selected from the group consisting of PFA, PTFE, and FEP.

As described above, when PFA, PTFE, or FEP is used as the fluororesin, the surface layer becomes far excellent in heat-resisting property and parting ability.

According to the present invention, the filler may be at least one member selected from the group consisting of a filler for imparting electrical conductivity, a filler for improving thermal conductivity, a filler for improving wear resistance, and a filler for improving strength.

As described above, when the surface layer contains a filler for imparting electrical conductivity or for improving thermal conductivity, wear resistance, or strength, the surface layer comes to have various improved properties.

According to the present invention, an intermediate layer may be provided between the elastic layer and the surface layer.

As described above, when an intermediate layer is provided between the elastic layer and the surface layer, an OA apparatus roller can be offered that can meet the required specification of various users in addition to the exercising of the above-described effect. More specifically, an intermediate layer made of highly heat-conductive rubber or electrically conductive rubber may be used. The intermediate layer may also be made of adhesive.

The present invention can offer an OA apparatus roller that has various excellent properties, that can meet the requirement of high-speed operation, and that can achieve a high picture quality.

### BRIEF DESCRIPTION OF THE DRAWINGS

FIGS. 1A and 1B are diagrams schematically showing the OA apparatus roller in an embodiment of the present invention, in which FIG. 1A is a diagram showing a cross section perpendicular to the axis and FIG. 1B is a perspective view.

FIG. 2 is a perspective view schematically showing a method of producing the OA apparatus roller in an embodiment of the present invention.

In the foregoing figures, the individual signs represent the following members; 1: OA apparatus roller; 2; Core metal; 3: Elastic layer; 4: Intermediate layer; 5: Surface layer; 5a: First surface layer (outer layer); 5b: Second surface layer (inner layer); and 6: Hollow cylindrical mold.

### DETAILED DESCRIPTION OF THE PREFERRED EMBODIMENTS

The present invention is concretely explained below. The present invention is not limited to the following embodiments. The following embodiments can be modified variously not only within the scope of the present invention but also within the equivalent scope of the present invention.

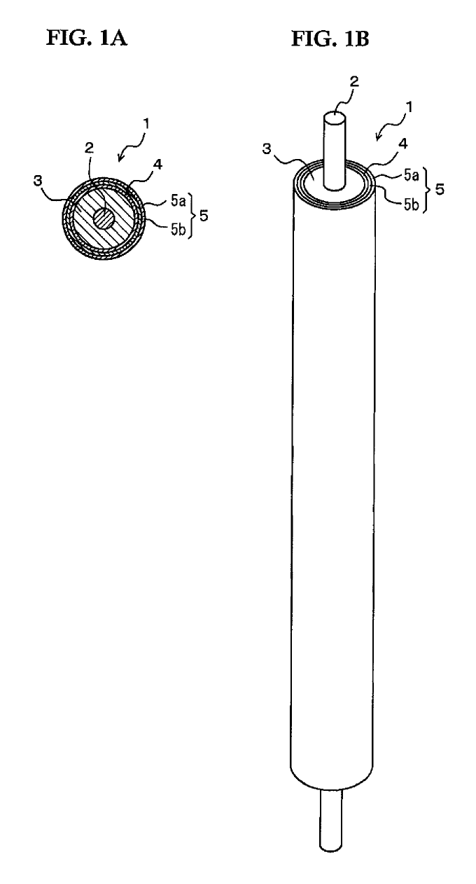

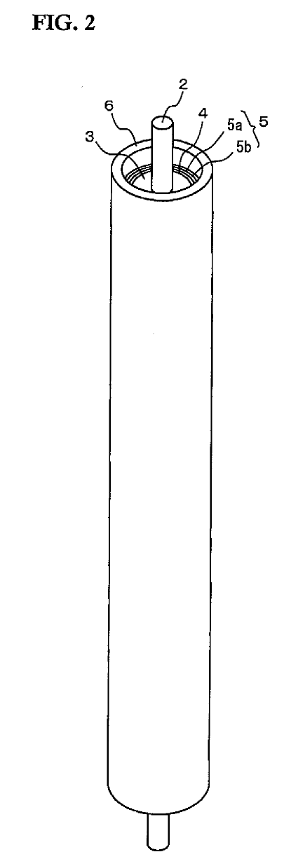

Embodiments of the present invention are explained below based on FIGS. 1A, 1B, and 2. FIGS. 1A and 1B are diagrams schematically showing the OA apparatus roller in an embodiment of the present invention. FIG. 1A is a diagram showing a cross section perpendicular to the axis of the roller and FIG. 1B is a perspective view FIG. 2 is a perspective view schematically showing a method of producing the OA apparatus roller in an embodiment of the present invention.

An OA apparatus roller 1 is provided with on a core metal 2 an elastic layer 3, an intermediate layer 4, and a surface layer 5 formed in this order from the interior. The surface layer 5 is composed of two layers having a first surface layer (an outer layer) 5a and a second surface layer (an inner layer) 5b. The OA apparatus roller 1 is produced by using a hollow cylindrical mold 6 and by forming the first surface layer 5a, the second surface layer 5b, the intermediate layer 4, and the elastic layer 3 in this order. The production method is explained below more specifically.

(a) A fluororesin dispersion containing significantly reduced amounts of the surfactant, film-thickening agent, and viscosity-increasing agent is applied (for example, by flow coating) onto the inner circumferential surface of the hollow cylindrical mold 6. The hollow cylindrical mold 6 is revolved around its own axis to perform the drying. The fluororesin is baked completely at a temperature as high as at least its melting point and at most 400° C. to form the first surface layer (the outer layer) 5a, which is a fluororesin layer having a thickness of 3 to 10 μm.

The types of surfactant include an ionic surfactant, such as a cationic surfactant and an anionic surfactant, and a nonionic surfactant. More specifically, the types of ionic surfactant include an anionic surfactant having a carboxylic acid group, sulfonic acid group, phosphoric acid group, or the like as a hydrophilic group and a cationic surfactant having tetraalkylammonium or the like as a hydrophilic group. The types of non-ionic surfactant include a low-molecule surfactant, such as alkyl glucoside, and a high-molecule surfactant, such as polyethylene glycol.

(b) To improve the bonding property, wettability, and hydrophilic property, the inner circumferential surface of the first surface layer 5a is treated, for example, by using plasma.

(c) A fluororesin dispersion that contains considerably reduced amounts of the surfactant, film-thickening agent, and viscosity-increasing agent and that further contains filler is applied (for example, by flow coating) onto the inner circumferential surface of the first surface layer 5a. After the drying operation is performed, the fluororesin is baked completely at a temperature as high as at least its melting point and at most 400° C. to form the second surface layer (the inner layer) 5b, which is a fluororesin layer having a thickness of 3 to 10 μm.

(d) The inner surface of the second surface layer 5b is treated, for example, by using plasma.

(e) In the case where an intermediate layer is formed, rubber having various properties is applied (for example, by flow coating) onto the inner circumferential surface of the second surface layer 5b. The hollow cylindrical mold 6 is revolved around its own axis to perform the drying. Thus, the intermediate layer 4 having a thickness of 50 to 150 μm is formed.

(f) The core metal 2 is inserted into the hollow space of the hollow cylindrical mold 6 so as to be coaxial with the hollow cylindrical mold 6. Foamable rubber is injected into the space between the intermediate layer 4 and the core metal 2. Then, the vulcanization is performed. Thus, the elastic layer 3 having a thickness of 1.5 to 3.5 mm is formed.

(g) Subsequently, the OA apparatus roller 1 is released from the hollow cylindrical mold 6.

In this embodiment, as described above, an explanation is given to the OA apparatus roller produced by using the hollow cylindrical mold 6. However, an OA apparatus roller of the present invention can also be produced without using the hollow cylindrical mold 6 through the following method. First, a fluororesin dispersion is applied onto the surface of the rubber layer or the intermediate layer. Then, the baking is performed to complete the production. The OA apparatus roller of the present invention can be more suitably used as a pressing roller and a fixing device roller.

### EXAMPLE

A concrete explanation is given below based on Example.

### (a) Formation of the Surface Layer

(a1) Formation of the First Surface Layer (the Outer Layer)

A PFA dispersion (EMX-047, made by Du Pont Co.), having a PFA content of 60 vol % and a surfactant content of 5 wt %, was applied onto the inner surface of the hollow cylindrical mold 6 that was made of stainless steel and that had an inner diameter of 18 mm and a length of 257 mm. The hollow cylindrical mold 6 was revolved around its own axis for 10 minutes at room temperature to perform the drying. The PFA was baked completely by heating it at 400° C. for 30 minutes. Thus, the first surface layer 5a having a thickness of 6 μm was formed on the inner circumferential surface of the hollow cylindrical mold 6.

(a2) Formation of the Second Surface Layer (the Inner Layer)

After the inner surface of the first surface layer 5a was plasma-treated, a PFA dispersion (EMX-041-2, made by Du Pont Co.), containing 14.5-vol % SiC filler, 0.07-wt % surfactant for dispersing the filler, and 1-wt % viscosity-increasing agent (methylcellulose), was applied onto the inner surface of the first surface layer 5a. The hollow cylindrical mold 6 was revolved around its own axis for 10 minutes at room temperature to perform the drying. The PFA was baked completely by heating it at 400° C. for 30 minutes. Thus, the second surface layer 5b having a thickness of 6 μm was formed on the inner circumferential surface of the first surface layer 5a.

### (b) Formation of the Intermediate Layer

After the inner surface of the second surface layer 5b was plasma-treated, Si rubber (highly heat-conductive rubber) (X32-2020, made by Shin-Etsu Chemical Co.) was applied (by flow coating) onto the inner circumferential surface of the second surface layer 5b. The hollow cylindrical mold 6 was revolved around its own axis to perform the drying. Thus, the intermediate layer 4 having a thickness of 100 μm was formed.

### (c) Formation of the Elastic Layer

(c1) Injection into the Mold

The core metal 2 made of aluminum was inserted into the hollow space of the hollow cylindrical mold 6. Foamable Si rubber (balloon rubber) (X34-2061-28L, made by Shin-Etsu Chemical Co.) was injected into the space between the intermediate layer 4 and the core metal 2.

(c2) Primary Vulcanization

The primary vulcanization was performed at 160° C. for 15 minutes including the temperature-rising period. Thus, the elastic layer 3 having a thickness of 1.5 mm was formed.

(c3) Releasing from the Mold

The OA apparatus roller 1 was released from the hollow cylindrical mold 6. No foreign matters were recognized on the inner surface of the hollow cylindrical mold 6. It was possible to form the surface layer through complete baking. The surface layer had a total thickness of 12 μm.

(c4) Secondary Vulcanization

The secondary vulcanization was performed at 250° C. for 30 minutes including the temperature-rising period.

### (d) Cutting and Finishing

The portions in the vicinity of both ends of the formed individual layers were removed by cutting. Then, cleaning and visual inspection were carried out. Thus, the production of the OA apparatus roller was completed.

In this example, the thickness of the surface layer was decreased and the intermediate layer made of highly heat-conductive rubber was provided. Consequently, the surface layer had a good thermal conductivity and then it was possible to produce an OA apparatus roller capable of meeting the requirement of high-speed operation. In addition, the surface layer was composed of two fluororesin layers, in which the first surface layer was composed of a fluororesin layer containing no filler. Consequently, the surface layer was able to secure the softness and good parting ability, thereby enabling the achieving of the high picture quality. Furthermore, the second surface layer was formed by containing the SiC filler. Thus, its wear resistance and strength were increased. As a result, it was possible to produce an OA apparatus roller also having excellent durability.

The produced OA apparatus roller was evaluated as a pressing roller. The result showed that the roller had an intended performance and the bonding property between the individual layers had no problem.

What is claimed is:

1. An OA apparatus roller, comprising a core metal, an elastic layer, and a surface layer;
wherein:
(a) the elastic layer and the surface layer are formed in this order on the core metal; and
(b) the surface layer is composed of a plurality of fluororesin layers and has a thickness of 6 to 30 μm.

2. The OA apparatus roller as defined by claim 1, wherein the surface layer has a thickness of 6 to 20 μm.

3. The OA apparatus roller as defined by claim 1, wherein of the multiple fluororesin layers forming the surface layer, at least one layer is a fluororesin layer containing filler.

4. The OA apparatus roller as defined by claim 3, wherein of the multiple fluororesin layers forming the surface layer, the outermost layer is a fluororesin layer containing no filler.

5. The OA apparatus roller as defined by claim 1, wherein the multiple fluororesin layers are composed of at least one member selected from the group consisting of PFA, PTFE, and FEP.

6. The OA apparatus roller as defined by claim 3, wherein the filler is at least one member selected from the group consisting of a filler for imparting electrical conductivity, a filler for improving thermal conductivity, a filler for improving wear resistance, and a filler for improving strength.

7. The OA apparatus roller as defined by claim 1, further comprising an intermediate layer between the elastic layer and the surface layer.

8. The OA apparatus roller as defined by claim 2, further comprising an intermediate layer between the elastic layer and the surface layer.

9. The OA apparatus roller as defined by claim 3, further comprising an intermediate layer between the elastic layer and the surface layer.

10. The OA apparatus roller as defined by claim 4, further comprising an intermediate layer between the elastic layer and the surface layer.

11. The OA apparatus roller as defined by claim 5, further comprising an intermediate layer between the elastic layer and the surface layer.

12. The OA apparatus roller as defined by claim 6, further comprising an intermediate layer between the elastic layer and the surface layer.
